(19) United States
(12) Patent Application Publication
(10) Pub. No.: US 2005/0278974 A1
(43) Pub. Date: Dec. 22, 2005

(54) Clothes dryer and method of displaying drying time on the same

(75) Inventor: Young Suk Chung, Suwon-Si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-si (KR)

(21) Appl. No.: 11/124,388

(22) Filed: May 9, 2005

(30) Foreign Application Priority Data
Jun. 16, 2004 (KR) 2004-44322

(51) Int. Cl. F26B 3/00; F26B 13/10

(52) U.S. Cl. 34/528; 34/562

(57) ABSTRACT

A clothes dryer and a method of displaying a drying time on the clothes dryer by determining a predicted drying time considering an ambient temperature of the clothes dryer and displaying the predicted drying time corresponding to the ambient temperature. Also, a clothes dryer and which displays the predicted drying time by determining a drying state of an object to be dried, and adjusting the predicted drying time based upon the drying state of object to be dried.

### CROSS-REFERENCE TO RELATED APPLICATIONS

This application claims the benefit of Korean Patent Application No. 2004-44322, filed on Jun. 16, 2004 in the Korean Intellectual Property Office, the disclosure of which is incorporated herein by reference.

### BACKGROUND OF THE INVENTION

1. Field of the Invention

The present invention relates to a clothes dryer and a method of displaying a drying time on the same, and, more particularly, to a clothes dryer which displays a predicted drying time corresponding to a drying condition.

2. Description of the Related Art

Generally, a clothes dryer includes a housing defining an appearance of the dryer, a drum equipped in the housing to receive clothes to be dried, a heating duct generating hot air supplied to the drum, a hot air-suction pathway guiding the hot air generated from the heating duct to the drum, and a hot air-exhaust pathway guiding the hot air exhausted from the drum to the outside of the housing.

The drum is rotatably positioned in the housing, and a blowing fan is positioned above the hot air-exhaust pathway to generate a flowing force of the hot air. The clothes dryer is provided with a driving motor for operating the drum and the blowing fan, and as the drum and the blowing fan are simultaneously driven by the operation of the driving motor, the hot air dries the clothes while circulating around the drum and respective ducts.

Meanwhile, a conventional clothes dryer further includes a temperature sensor detecting the temperature in the drum, and a humidity sensor detecting the humidity in the drum, thereby determining and displaying a predicted drying time of the clothes received in the drum using the temperature and the humidity detected by the temperature sensor and the humidity sensor, respectively.

However, since the conventional clothes dryer determines the predicted drying time without considering an ambient temperature, there is a problem in that the predicted drying time is inaccurate. That is, when determining the predicted drying time, the conventional clothes dryer does not take into account that a higher ambient temperature results in a shorter drying time and a lower ambient temperature results in a longer drying time. As a result, there is a problem in the conventional clothes dryer that the predicted drying time does not coincide with the actual drying time.

Furthermore, since the conventional clothes dryer determines the predicted drying time by measuring the temperature or the humidity in the drum without determining a drying state of the clothes, there is a difference between the predicted drying time and the actual drying time.

### SUMMARY OF THE INVENTION

Accordingly, it is an aspect of the invention to provide a clothes dryer and a method of displaying a drying time on the same, which determines a predicted drying time considering an ambient temperature of the clothes dryer.

Additional aspects and/or advantages of the invention will be set forth in part in the description which follows and, in part, will be apparent from the description, or may be learned by practice of the invention.

The foregoing and/or other aspects of the present invention are achieved by providing a clothes dryer and a method of displaying the drying time, which displays the predicted drying time corresponding to a drying state of clothes to be dried.

It is another aspect of the present invention to provide a method of displaying a drying time of a clothes dryer, the method including measuring an ambient temperature of the clothes dryer, and displaying a predicted drying time of an object to be dried in the clothes dryer based upon the measured ambient temperature.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a cross-sectional view illustrating a clothes dryer according to an embodiment of the present invention;

FIG. 2 is a block diagram illustrating the clothes dryer of FIG. 1;

FIG. 3 is a table showing a predicted drying time displayed according to the ambient temperature of the clothes dryer of FIG. 2;

FIG. 4 is a table showing a corrected range of the predicted drying time initially displayed on the clothes dryer of FIG. 2; and

FIG. 5 is a flow diagram illustrating operations of the clothes dryer of FIG. 2.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

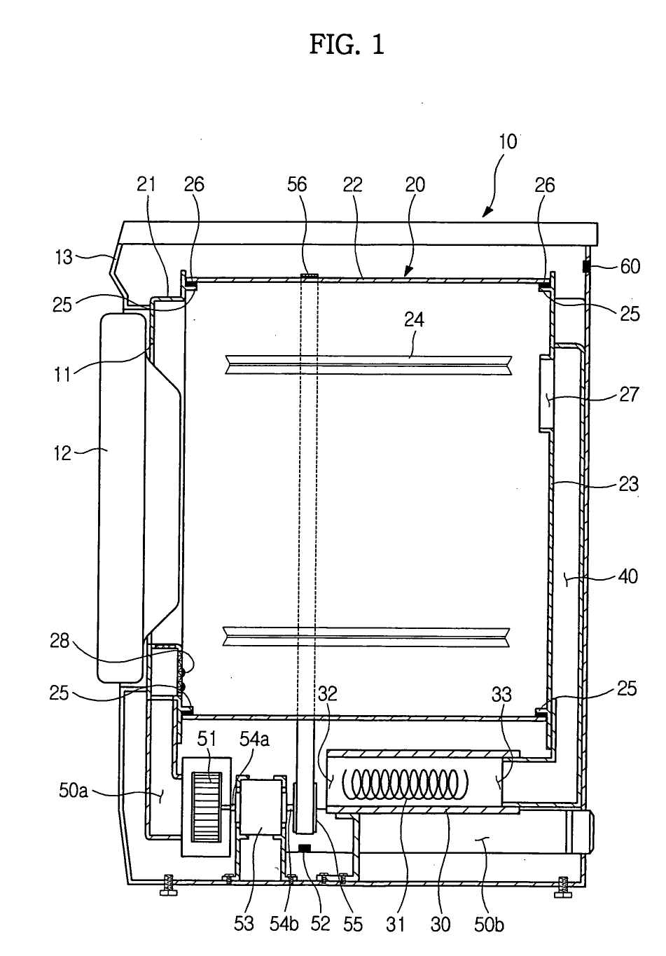

Referring to FIG. 1, a clothes dryer according to an embodiment of the present invention includes a housing 10 defining an appearance of the clothes dryer, a cylindrical drum 20 equipped in the housing to receive clothes to be dried, a heating duct 30 generating hot air supplied to the drum, a hot air-intake pathway 40 guiding the hot air generated in the heating duct 30 to the drum 20, and a hot air-exhaust pathway 50a and 50b guiding the hot air exhausted from the drum 20 to the outside of the housing 10, and an ambient temperature sensor 60 detecting the ambient temperature of the clothes dryer.

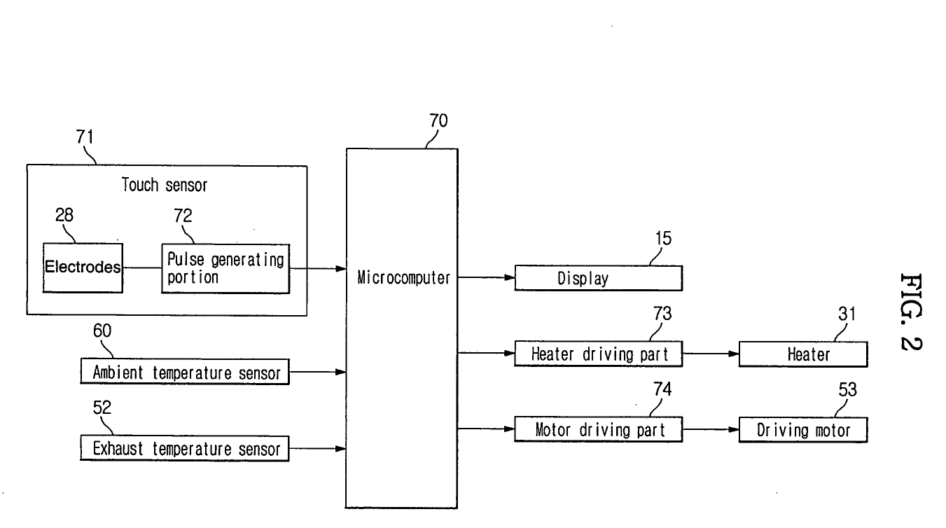

The housing 10 includes an input port 11 in a front portion thereof, to input and remove the clothes, and a door 12 hinged to one side of the input port 11 to open or close the input port 11. The housing 10 further includes a control panel 13 at an upper portion of the front portion thereof, including an operating button (not shown) to control operations of respective driving elements, a display 15 (shown in FIG. 2) to display a predicted drying time and the operations of the respective driving elements.

The drum 20 includes a front panel 21 facing a door 12 and having an opening at the center of the drum 20, a rear panel 23 provided at a rear portion in the housing and having a hot air-intake port 27 at an upper portion of the rear panel 23, and a side panel 22 rotatably provided between the front panel 21 and the rear panel 23.

The front panel 21 is provided at a lower portion thereof with two bar-shaped electrodes 28 elongated in the lengthwise direction and having sides slightly protruded in a direction of the rear panel 23 of the drum 20. These two bar-shaped electrodes 28 constitute a touch sensor 71 shown in FIG. 2.

A plurality of lifters 24 are arranged on an inner peripheral surface of the drum 20 while protruding to the center of the drum 20 and extending in the longitudinal direction along the drum 20, raising the clothes (not shown) to the top of the drum 20 and then releasing the clothes to be dropped to the bottom of the drum 20 according to a rotation of the side panel 22, thereby uniformly mixing the clothes. The side panel 22 is supported at both inner ends thereof by supporting members 25 protruded from the front panel 21 and the rear panel 23 to the side panel 22, respectively, and sliding pads 26 are interposed between the supporting members 25 and both ends of the drum 20, respectively, to allow an easy sliding movement of the side panel 22.

A heater 31 is installed in a heating duct 30 to heat air taken in from the inside of housing 10 to the heating duct 30. The heating duct 30 is provided at a front end thereof with an intake port 32 to intake the air from the inside of the housing 10, and at a rear end of the heating duct 30 with an exhaust port 33 communicated to a hot air-intake pathway 40 to send heated air to the drum 20.

The hot air-intake pathway 40 having one end communicated with the exhaust port 33 of the heating duct 30, and another end communicated with the hot air-intake port 27 of the rear panel 23 of the drum after being extended and bent to an upper portion of the housing 10 at the rear of the housing 10. Furthermore, the hot air-exhaust pathway 50a and 50b is connected to a lower portion of the front panel 21 of the drum 20, and communicated with an outside of the housing 10 along a lower surface of the housing 10. A blowing fan 51 to supply a flowing force required to intake and exhaust the hot air, and an exhaust temperature sensor 52 positioned within the air-exhaust pathway 50a and 50b, to detect a temperature of the exhausted air.

When rotating the blowing fan 51, the hot air generated in the heating duct 30 is guided into the drum 20. The hot air supplied into the drum 20 evaporates moisture contained in the clothes, and is then exhausted to the outside of the housing 10 along the air-exhaust pathway 50a and 50b.

The driving motor 53 transmits a rotational force both to the blowing fan 51 and the side panel 22 of the drum 20, and thus a driving shaft including portions 54a and 54b of the driving motor 50 is extended in the longitudinal direction. Here, the blowing fan 51 is connected to the portion 54a of the driving shaft extended to the front side of the driving motor 53, and a pulley 55 for driving the side panel 22 of the drum is fixed to the portion 54b of the driving shaft extended to the rear side of the driving motor 53. The pulley 55 is connected to the side panel 22 of the drum 20 by a transmission belt 56, so that the rotational force of the driving motor 50 is transmitted to the side panel 22 of the drum 20. Accordingly, the blowing fan 51 and the side panel 22 of the drum 22 are simultaneously rotated.

Referring to FIG. 2, shows the clothes dryer of FIG. 1 further includes a touch sensor 71 generating a pulse when the clothes inputted to the drum contact the electrodes 28, a heater driving part 73 driving a heater 31, a motor driving part 74 driving the driving motor 53, and a microcomputer 70 controlling the above components and storing various types of data required for displaying a predicted drying time on the display 15.

The touch sensor 71 includes the two bar-shaped electrodes 28, and a pulse generating portion 72 to generate a pulse when the current flows between the electrodes 28. When the clothes containing the moisture contact two electrodes 28 of the touch sensor 71, currents are generated between the two electrodes 28 through the moisture of the clothes, whereby the pulse is generated and inputted into the microcomputer 70.

When a large amount of moisture is contained in the clothes, the currents are easily generated between the electrodes 28 through the moisture upon contact of the clothes with the two electrodes 28, and thus the number of the pulses generated for a predetermined time is increased. However, when a small amount of moisture is contained in the clothes, the currents are not easily generated between the electrodes 28 even though the clothes contact the two electrodes 28 at the same time, and thus the number of the pulses generated for the predetermined time is decreased in comparison to when a large amount of moisture is contained in the clothes. That is, the number of the pulses generated for a predetermined time is dependent upon the amount of moisture contained in the clothes inputted in the drum. Therefore, the amount of moisture contained in the clothes inputted may be determined.

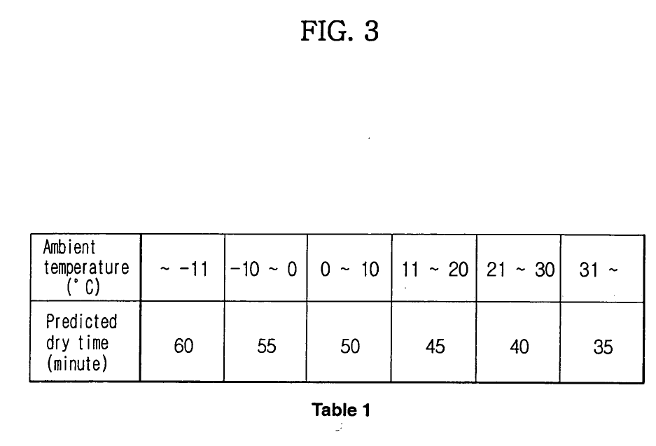

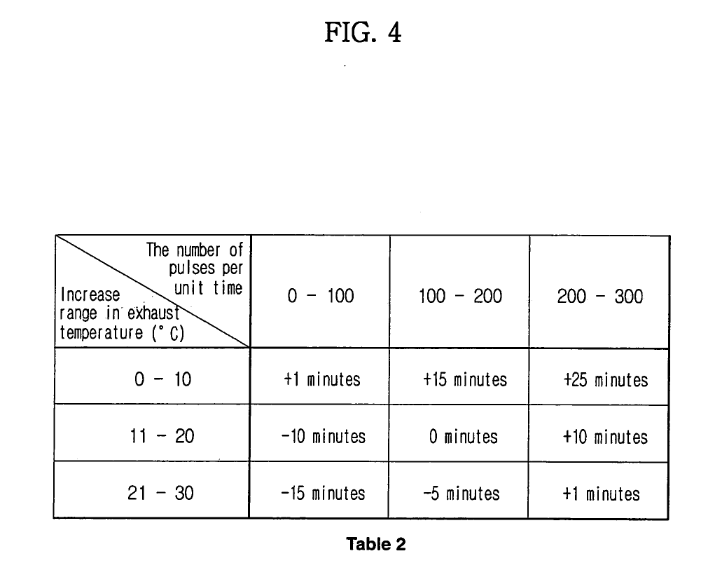

The microcomputer 70 stores drying time information (shown in Table 1 of FIG. 3) including a predicted drying time to be displayed on the display 15 corresponding to an ambient temperature of the clothes dryer, and a correction range of the predicted time set corresponding to variations in exhaust temperature for a predetermined time and in the number of pulses generated in the touch sensor 71 for a predetermined time (as shown in Table 2 of FIG. 4).

As the ambient temperature is lowered, the temperature of air introduced into the heating duct 30 is also lowered, thereby lowering the temperature of the hot air heated by the heater 31 and supplied to the drum 20, so that the drying time is increased. Thus, as shown in Table 1 of FIG. 3, considering this fact, the clothes dryer of the present invention extends the predicted drying time displayed on the display 15 when the ambient temperature is low, and on the contrary, the dryer shortens the predicted drying time displayed on the display 15 when the ambient temperature is high.

An initial predicted drying time of Table 1 of FIG. 3 displayed on the display 15 is set on the basis of a predetermined state of the clothes. For example, Table 1 of FIG. 3 is established considering the drying time corresponding to an ambient temperature under the condition that the clothes received in the drum 20 have a weight of 7 lb, and contains 75% moisture. As shown in Table 1 of FIG. 3, even though other conditions are the same, there are differences between a lowest predicted drying time and a highest predicted drying time according to the ambient temperature. However, the predicted drying time appropriately corresponding to the ambient temperature is displayed, so that a user can be determined of an accurate drying completion time.

The predicted drying time displayed in Table 1 is revised, as shown in Table 2 of FIG. 4, according to an increase range in exhaust temperature or the number of pulses per unit time. In Table 2 of FIG. 4, the term “increase range in exhaust temperature” means a degree of variation in temperature of air exhausted to the outside from the drum 20. When a large amount of clothes is received in the drum 20, even though the hot air in supplied to the drum 20 for a predetermined time, the increase range in exhaust temperature is not high. In contrast, when a small number of clothes are received in the drum 20, if the hot air is supplied to the drum 20 for a predetermined time, the increase range in exhaust temperature is high. Accordingly, the amount of the clothes received in the drum 20 can be determined by inversely using the increase range in exhaust temperature. A degree of correction in the predicted drying time displayed according to the increase range in exhaust temperature can be appropriately set through experimentation.

Furthermore, the number of pulses per unit time means the number of pulses generated from the pulse generation portion 72 (shown in FIG. 2) for a predetermined time. The number of pulses is changed according to the amount of moisture contained in the clothes. That is, when the amount of moisture contained in the clothes is large, a relatively large number of pulses are generated, but when the amount of moisture contained in the clothes is small, a relatively small number of pulses are generated.

When the increase range in exhaust temperature is approximately 11˜20° C. and the number of pulses per unit time is approximately 100˜200, as in Table 2 of FIG. 4, which are the same conditions when determining the predicted drying time in Table 1 of FIG. 3 (for example, when the clothes received the drum 20 have a weight of 7 lb, and contain 75% moisture), the predicted drying time initially displayed on the display part 15 is maintained. However, when the increase range in exhaust temperature is higher than 11˜20° C. (that is, when the clothes received the drum 20 have a weight less than 7 lb as a reference amount of the clothes) or the number of pulses per unit time is less than 100˜200 (that is, when the clothes received in the drum 20 contain less than 75% moisture as a reference amount of moisture contained in clothes), the predicted drying time initially displayed on the display 15 according to Table 1 of FIG. 3 is reduced as shown in Table 2 of FIG. 4, and displayed thereon.

On the contrary, when the increase range in exhaust temperature is lower than 11˜20° C. (that is, when the clothes received in the drum 20 have a weight more than 7 lb as the reference amount of the clothes) or the number of pulses per unit time is higher than 100˜200 (that is, when the clothes received the drum 20 contain more than 75% moisture as the reference amount of moisture contained in clothes), the predicted drying time initially displayed on the display 15 according to Table 1 of FIG. 3 is increased as is shown in Table 2 of FIG. 4, and displayed thereon.

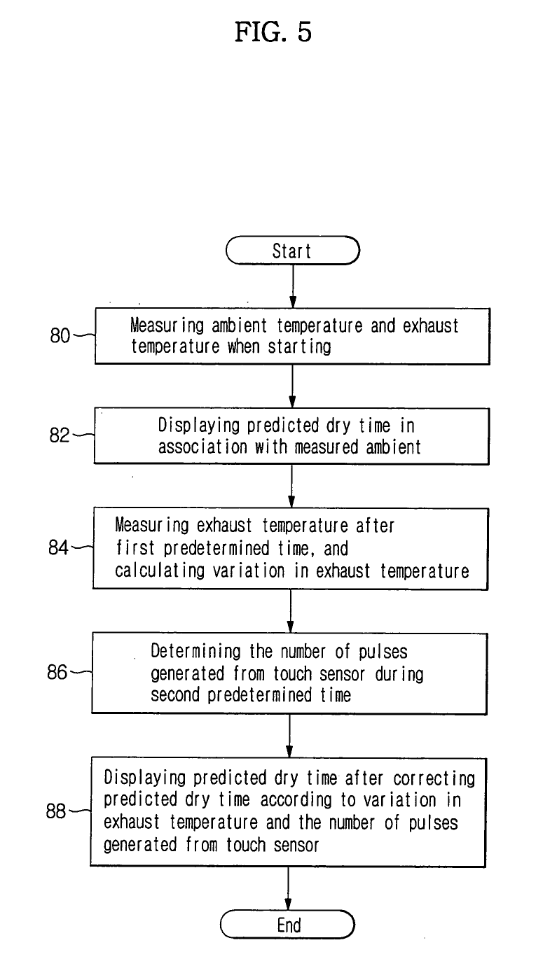

Operations of the clothes dryer shown in FIG. 2 will be described with reference to FIG. 5. In FIG. 5, when a drying operation is started, the heater driving part 73 drives the heater 31, and the motor driving part 74 drives the driving motor 53 to rotate the blowing fan 51. In operation 80, an ambient temperature is measured with the ambient temperature sensor 60, and the temperature of air exhausted to the outside of the drum is measured with the exhaust temperature sensor 52.

When the heater 31 and the blowing fan 51 are operated, hot air is supplied to the drum 20 through the hot air-intake pathway 40, evaporates moisture contained in clothes, and is then exhausted to the outside of the clothes dryer through the hot air-exhaust pathway 50a and 50b.

From operation 80, the process moves to operation 82, where the microcomputer 70 displays a predicted drying time corresponding to the ambient temperature measured, with reference to Table 1 of FIG. 3.

From operation 82, the process moves to operation 84 where when a first predetermined time after the measurement of the exhaust temperature passes, the exhaust temperature is measured again with the exhaust temperature sensor 52, and the increase range in exhaust temperature is determined by comparing this measurement with the measured exhaust temperature obtained in operation 80. At this time, the first predetermined time may be appropriately selected through experimentation.

From operation 84, the process moves to operation 86, where the number of pulses, generated from the touch sensor 71 during a second predetermined time after the drying operation, is determined. The second predetermined time may be appropriately selected through experimentation.

From operation 86, the process moves to operation 88, where when the increase range in exhaust temperature and the number of pulses from the touch sensor 71 are determined, the microcomputer 70 displays a predicted drying time after correcting the initially predicted drying time with reference to Table 2 of FIG. 4.

As is described in detail above, the present invention changes the initially predicted drying time according to the ambient temperature, thereby displaying the predicted drying time corresponding to the actual drying time.

Furthermore, the initially predicted drying time is changed according to the amounts of the clothes inputted into the drum and the amount of moisture contained in the clothes as well as the ambient temperature, so that an accurately predicted drying time can be displayed.

Although a few embodiments of the present invention have been shown and described, it would be appreciated by those skilled in the art that changes may be made in this embodiment without departing from the principles and spirit of the invention, the scope of which is defined in the claims and their equivalents.

1. A method of displaying a drying time of a clothes dryer, comprising:
measuring an ambient temperature of the clothes dryer; and
displaying a predicted drying time of an object to be dried in the clothes dryer corresponding to the ambient temperature.

2. The method according to claim 1, further comprising a controller, wherein the predicted drying time is predetermined, set and stored in the controller.

3. A method of displaying a drying time of a clothes dryer, the method comprising:
displaying a predicted drying time of an object to be dried in the clothes dryer;
determining a drying state of the object to be dried; and
adjusting the predicted drying time based upon the drying state of the object to be dried.

4. The method according to claim 3, wherein the drying state of the object to be dried is determined based on factors including a variation in temperature of air exhausted from the clothes dryer to an outside thereof, and an amount of moisture contained in the object to be dried.

5. The method according to claim 4, wherein the amount of moisture contained in the object to be dried is measured by using an output of a touch sensor provided in the clothes dryer.

6. The method according to claim 5, wherein the amount of moisture contained in the object to be dried is measured by determining the number of pulses generated from the touch sensor for a predetermined time.

7. The method according to claim 6, further comprising adjusting the predicted drying time of the object to be dried based upon the number of pulses measured.

8. A method of displaying a drying time of a clothes dryer, comprising:
measuring an ambient temperature of the clothes dryer;
displaying a predicted drying time of an object to be dried in the clothes dryer corresponding to the ambient temperature measured;
determining a drying state of the object to be dried; and
adjusting the predicted drying time based upon the drying state of the object to be dried.

9. The method according to claim 8, wherein the drying state of the object to be dried is determined based on factors including a variation in temperature of air exhausted from the clothes dryer to an outside thereof, and an amount of moisture contained in the object to be dried.

10. A clothes dryer, comprising:
an ambient temperature sensor to measure an ambient temperature of the clothes dryer;
a display to display a predicted drying time of an object to be dried in the clothes dryer;
a controller to control the display to display the predicted drying time corresponding to the ambient temperature measured.

11. The clothes dryer according to claim 10, wherein the clothes dryer further comprises:
moisture detecting means provided in the dryer to detect an amount of moisture contained in the object to be dried; and
an exhaust temperature sensor to measure a temperature of air exhausted from the clothes dryer to an outside thereof.

12. The clothes dryer according to claim 11, wherein the controller controls the display to display the predicted drying time after adjusting the predicted drying time based upon a drying state of the object to be dried.

13. The clothes dryer according to claim 12, wherein the drying state of the object to be dried is determined based on factors including a variation in temperature of the air exhausted from the clothes dryer to an outside thereof, and an amount of moisture contained in the object to be dried.

14. The clothes dryer according to claim 11, wherein the moisture detecting means is a touch sensor generating pulses when contacting the object to be dried containing the moisture therein, and the amount of moisture contained in the object is determined by measuring the number of pulses generated from the touch sensor.

15. A drying method of a clothes dryer, comprising:
inputting an object to be dried into the clothes dryer;
supplying hot air to the an interior of the clothes dryer;
displaying a predicted drying time to dry the object corresponding to an ambient temperature of the clothes dryer; and
adjusting the predicted drying time based upon a drying state of the object to be dried.

16. A drying method of a clothes dryer, comprising:
measuring an ambient temperature and an initial exhaust temperature of the clothes dryer;
displaying a predicted drying time corresponding to the measured ambient temperature;
measuring an exhaust temperature after a first predetermined time, and calculating a variation in the initial exhaust temperature measured and the exhaust temperature measured after the first predetermined time;
determining a number of pulses generated by a sensor corresponding to an amount of moisture contained in an object to be dried, during a second predetermined time; and
adjusting and displaying the predicting drying time of the object, based upon the calculated variation and the number of pulses generated.
